(19) United States
(12) Patent Application Publication
(10) Pub. No.: US 2026/0054107 A1
(43) Pub. Date: Feb. 26, 2026

(54) BELT FOR PERSONAL FALL PROTECTION COMPRISING A TWO-PIECE FITTING PART

(71) Applicant: TEUFELBERGER FIBER ROPE GMBH, Wels (AT)

(72) Inventor: Patrick JOHRENDT, Gunskirchen (AT)

(21) Appl. No.: 19/105,684

(22) PCT Filed: Aug. 11, 2023
(86) PCT No.: PCT/EP2023/072270

§ 371 Date: Feb. 21, 2025

(30) Foreign Application Priority Data
Aug. 24, 2022 (EP) 22192015.0

(51) Int. Cl. A62B 35/00

(52) U.S. Cl. CPC A62B 35/0012; A62B 35/0031; A62B 35/0037

(57) ABSTRACT

The disclosure relates to a belt and includes a fitting part and at least a first and a second belt sub-element enclosing a body part, the fitting part including a body that is designed to be connected to the first belt sub-element, to the second belt sub-element and to a flexible bridge, with the body of the fitting part including a first part and a second part which can be brought into an assembled state and into a separated state, with the first part and/or the second part including at least one first external groove for the first belt sub-element. In the assembled state, the first groove is completed by the respective other part to form the first webbing opening passing through the body in order to connect therein a first webbing of the first belt sub-element enclosing a body part to the fitting part in a semi-permanent way.

### BACKGROUND

The invention relates to a belt for personal fall protection comprising a fitting part and at least a first and a second belt sub-element enclosing a body part, the fitting part comprising a body that is designed to be connected to the first belt sub-element, to the second belt sub-element and to a flexible bridge.

In the field of personal safety, in particular in the field of tree care, belts are used to secure climbers against falling. The belts typically comprise several belt sub-elements enclosing body parts, such as, for example, a hip belt, a chest belt and/or leg slings. The belt sub-elements are connected to each other by means of fitting parts, and generally it is possible to attach further elements such as rope bridges to the fitting parts. Usually, one fitting part is provided on the left of the belt and one fitting part is provided on the right thereof, and the rope bridge is attached between the fitting parts depending on the design of the fitting part using knots or slings at the ends of the rope bridge. The rope bridge can thus be used as an anchor point, e.g., it can be hooked into a safety device, and the user can lean back while being secured.

Embodiments having shackles as fitting parts are known, wherein a webbing of the waist belt, a webbing of the leg sling and one end of the rope bridge are suspended on a U-shaped body of the shackle during assembly. The U-shaped body can be closed using a bolt so that the above-mentioned elements are secured on the shackle. In the assembled state, the end of the rope bridge then usually ends up lying on the bolt. Such embodiments involve the disadvantage that all elements are released when the bolt is being removed and that there are no dedicated webbing openings and thus all webbings or, respectively, the flexible bridge rub against each other. However, the modular design of this embodiment, particularly with regard to the interchangeability of the rope bridge, has always been regarded as a positive feature.

Other fitting parts are designed as rigid bodies and have two separate webbing openings for the webbing of the hip belt or, respectively, for the webbing of the leg sling. Furthermore, a bridge hole is provided in which the rope bridge can be fixed using a stopper knot.

An obvious modification as known from EP 3 332 840 A provides for the use of the detachable fastening element known from the shackles with an otherwise rigid fitting part. To implement this, a bone-shaped fastening strip or installation strip is screwed over the bridge hole on the outside. In this embodiment, the webbing openings remain unchanged, as is the case with fitting parts having rigid bodies.

From EP 3 466 493 B1, a fitting part provided with an aperture on one side is known. A closing element can be inserted into the aperture, which completes the shape of the fitting part and substitutes a partition in the fitting part. The closing element thus separates the bridge hole from an opening for an anchor point. In this embodiment, too, the webbing openings remain unchanged, as is the case with fitting parts having rigid bodies.

However, belts comprising fitting parts with bodies that are passed through by two webbing openings in the usual way are complex to manufacture and difficult to maintain, respectively. First, the belt sub-elements must be provided with webbings, with the ends of the webbings being designed so as to be loose. Afterwards, the webbings are passed through the respective webbing openings of the fitting part, and subsequently they are sewn up to form a loop, with the fitting part located within the loop. In this way, the belt sub-elements can be permanently connected to the fitting part. In this case, it is not possible to replace the fitting part and/or belt sub-elements for maintenance purposes.

EP 3 228 362 B1 discloses a belt for personal fall protection. In this case, a fitting part with two parts is used, which are interconnected by a cylindrical pin. A loop of a webbing is threaded onto the pin. The pin is mounted in a rotatable manner so that all individual parts can be twisted relative to each other.

### BRIEF SUMMARY

It is the object of the invention to create a belt for personal fall protection that is easier to manufacture and, respectively, whose elements can be replaced more easily.

This object is achieved by a belt for personal fall protection comprising a fitting part and at least a first and a second belt sub-element enclosing a body part, the fitting part comprising a body that is designed to be connected to the first belt sub-element, to the second belt sub-element and to a flexible bridge, wherein the body is passed through by a first webbing opening and by a bridge hole, with the body of the fitting part comprising a first part and a second part which can be brought into an assembled state and into a separated state, with the first part and/or the second part comprising at least one first external groove for the first belt sub-element, wherein, in the assembled state of the two parts, the first groove is completed by the respective other part to form the first webbing opening passing through the body in order to connect therein a first webbing of the first belt sub-element enclosing a body part to the fitting part in a semi-permanent way, with the body of the fitting part furthermore having at least one transverse hole passing through both the first part and the second part, with the fitting part furthermore comprising a screw, and wherein the screw can be guided into the transverse hole and can be locked therein in order to connect the first part to the second part in the assembled state.

The two-piece fitting part of this belt allows the webbing opening, which is separate from the bridge hole, to be designed so as to be openable, which was previously unknown in the prior art. As a result, it is rendered possible for the first time in a first aspect that the belt sub-elements can be manufactured completely before they are connected to the fitting part. i.e., the ends of the webbings of the belt sub-elements can be sewn up to form loops in advance before they are connected to the fitting part. In a second aspect, it is rendered possible for the first time that the belt sub-elements or, respectively, the fitting part can be replaced even after initial assembly.

Herein, the notion of a “semi-permanent” connection is used synonymously with a “detachable” connection and is supposed to underline that the two parts are usually not detached from each other during use, but are separable before or after use, preferably using tools, e.g., using a screwdriver, in order to loosen the screws described below.

In order to connect the two parts to each other in a semi-permanent way, the body of the fitting part preferably has at least one transverse hole, the transverse hole passing through both the first part and the second part, with the fitting part furthermore comprising a screw, wherein the screw can be guided into the transverse hole and can be locked therein in order to connect the first part to the second part in the assembled state. Screws with threads are particularly preferred as they can be loosened easily by means of a tool and, at the same time, they offer a high level of protection against accidental loosening of the screw and subsequently of the two parts. For this purpose, the transverse hole can exhibit an internal thread that is, for example, cut directly into the respective part. Alternatively, the transverse hole could have an area with a larger diameter in which a screw nut exhibiting the internal thread is incorporated. In order to prevent the screws from coming loose in case of vibrations, an adhesive could also be provided between the transverse hole and the screw, preferably between the thread of the screw and the internal thread of the transverse hole.

Locking the screw in the transverse hole has the effect that it will be present in the transverse hole in an essentially immobile state, i.e., it can be neither moved nor twisted without a tool. As a result, the two parts can subsequently be connected to each other in a semi-permanent and non-rotatable way in order to form a rigid body.

The new fitting parts therefore create a possibility of assembling or, respectively, maintaining the belt independently of the webbings of the belt sub-elements. The solution according to the invention is advantageous especially if the end of the first webbing of the first belt sub-element, which is to be connected to the fitting part, is sewn up to form a loop.

The first part and the second part are designed as flat parts so that together they form the flat body of the fitting part. In other words, the two parts are not designed as cylindrical pins. However, it shall be understood that the flat parts can also have a local thickening, e.g., in the area of a transverse hole. The flat parts usually extend in one plane and can have an essentially D-shaped or C-shaped design, for example. The flat parts preferably have a planar front side and a planar back side, which are located in parallel to each other.

When the two parts are in the assembled state, they usually form the outer contour of the body, i.e., neither of the two parts forms an exclusively internal part of the body. Optionally, a third part can also form part of the outer contour of the body. As a rule, the first part and the second part, optionally also the first part, the second part and the third part, together form the entire outer contour of the body, as viewed from the front side toward the back side.

In the assembled state, the loop of the first webbing of the first belt sub-element encloses the first or second part. Likewise, the loop of the second webbing of the second belt sub-element can enclose the first part, the second part or even a third part.

Moreover, in the assembled state, the first and the second parts are preferably connected to each other in such a way that they are located non-rotatably relative to each other, which can be achieved, as explained below, by means of screw connections or guides, for example.

Webbing openings are herein understood to be especially openings that essentially have the shape of the webbing to be accommodated and thus, for example, exhibit an elongated shape. The webbing openings are usually designed to be slightly larger than the webbings to be accommodated in order to facilitate assembly.

In one embodiment, it would be possible for both the first webbing of the first belt sub-element and the second webbing of the second belt sub-element to be accommodated in the first webbing opening, whereby a second webbing opening can be omitted. In this case, however, the webbings touch each other so that wear and tear can happen. In order to prevent this and to make use of the advantage according to the invention for the webbings of both belt sub-elements, the first part and/or the second part preferably comprise(s) at least one second external groove for the second belt sub-element, wherein, in the assembled state of the two parts, the second groove is completed by the respective other part to form a second webbing opening passing through the body in order to connect therein a second webbing of the second belt sub-element enclosing a body part to the fitting part.

As already explained at the outset, the body is passed through by the first webbing opening (and possibly also by the second webbing opening) as well as by a bridge hole. In the simplest case, the first or the second part is passed through by the bridge hole, i.e., the bridge hole is not present as a groove on an outer side of the part. In this case, the flexible bridge can be anchored in the bridge hole by means of a knot. However, the first part and/or the second part can preferably comprise at least one third external groove for the flexible bridge, wherein, in the assembled state of the two parts, the third groove is completed by the respective other part to form a bridge hole passing through the body in order to connect therein the flexible bridge to the fitting part. When assembling the fitting part, not only the webbings of the belt sub-elements, but also the flexible bridge, can be connected to the fitting part in a semi-permanent way in this manner.

The two above-mentioned embodiments have in common that the first part and/or the second part comprise(s) at least one further external groove (for the second belt sub-element or the flexible bridge), wherein, in the assembled state of the two parts, the further groove is completed by the respective other part to form a further opening passing through the body (e.g., the second webbing opening or the bridge hole). As a result, a second webbing of the second belt sub-element enclosing a body part or the flexible bridge can be connected to the fitting part. This fitting part thus allows at least two separate openings to be cleared simultaneously when the two parts are dismantled.

In a preferred variant, the transverse hole is arranged at a predetermined distance from a front side and a back side of the body, i.e., the transverse hole runs essentially in parallel to the front side and the back side therebetween. In contrast to the webbing openings or, respectively, the bridge hole, which pass through the front side and the back side of the body in the assembled state, the transverse hole thus enters the body in this variant from one side surface thereof and can therefore run through both parts so that they can be connected by screws. Screws with threads are particularly preferred as they can be loosened easily by means of a tool and, at the same time, offer a high level of protection against accidental loosening of the screw and subsequently of the two parts.

As an alternative to the above-mentioned variant, the transverse hole can also pass through a front side and a back side of the body, i.e., running essentially in parallel to the webbing openings and the bridge hole. In this case, it is usually envisaged that one of the parts comprises a projection which can be inserted into a groove in the respective other part, with the transverse hole running through the projection and the outer sides of the groove.

As is known per se to those skilled in the art, the fitting part furthermore has a pull direction which is the direction in which the fitting part is mainly stressed when the belt is in use. As a rule, the fitting part is essentially symmetrical around the pull direction, which also takes into account minor deviations from symmetry in order to adapt the fitting part to anatomical conditions. Since the greatest force acts on the screws in the pull direction, it is preferred if the transverse hole is arranged at an angle to the pull direction. Furthermore, it is preferred if two transverse holes, each with one screw; are used and the transverse holes are likewise located symmetrically around the pull direction, which is not mandatory, however. Furthermore, the two parts are also designed symmetrically around the pull direction. In the simplest case, what can be regarded as a simple definition of the pull direction is a direction around which the body is mirror-symmetrical, wherein the webbing openings may deviate from mirror symmetry, if necessary.

The screws or generally the connectors for the semi-permanent connection of the two parts are usually selected such that the fitting part will withstand the action of a static force of at least 23 kN along the pull direction. To implement this, the screws have a minimum diameter of 5 mm, for example. This is dimensioned for a case in which two screws are used, these are fully load-bearing in the pull direction and the highest strength class is chosen for the screws.

Furthermore, in all above-mentioned embodiments, it is preferred if the body comprises a web which divides the bridge hole, i.e., passing through or bridging it. This is advantageous especially in combination with the aforementioned third groove if the web is furthermore opened on one side when the two parts are separated. In the separated state, an end of the flexible bridge which has been pre-formed, in particular sewn up, to form a loop can thereby be pushed onto the web. When the two parts are then assembled, this pre-formed loop of the flexible bridge can be anchored securely in the bridge hole.

As already explained, the body of the fitting part as well as the parts are usually designed symmetrically around a pull direction. In this variant, the web is preferably located in parallel to the pull direction or, respectively, the axis of symmetry, and particularly preferably the pull direction or, respectively, the axis of symmetry runs through the web. As a result, the web can be rendered accessible in a particularly easy way, since the open end of the web is made accessible by separating the two parts.

Preferably, the web is thus integrally formed on the first part or on the second part and protrudes from the third groove. Alternatively, the web could be formed as a separate element and inserted, for example, as a pin between the first part and the second part. In both cases, it is furthermore advantageous if the part opposite the web comprises a recess for receiving the web (particularly if the web has a diameter that is smaller than the thickness of the body) or for receiving an extension of the web in the assembled state of the parts, since the web is thereby supported on two sides and can thus withstand greater loads. As an alternative to the recess, a pin which engages into a web with a tubular design could be used.

In a further preferred embodiment, the above-mentioned screw; which connects the first part to the second part, can also perform a double function and can form the web when it passes through the bridge hole. As a result, a particularly stable web is created, which is more robust than a web integrally moulded on the second part. In this embodiment, the web will usually be located normally to the pull direction, but an arrangement in parallel to the pull direction is also conceivable.

In order to further increase the stability of the body after the two parts have been assembled and to facilitate correct assembly, the first part and the second part preferably have interlocking guide surfaces at the points touching each other in the assembled state of the two parts. These interlocking guide surfaces in particular provide support to prevent the two parts from twisting relative to each other.

It has proved to be particularly advantageous if the body has a thickness, measured from the front side to the back side, of 6 mm to 14 mm, preferably of 8 mm to 10 mm. Furthermore, the transverse hole preferably has a diameter of 5 mm to 10 mm, preferably of 6 mm to 8 mm.

The belt described herein could indeed be used for all possible application purposes, however, its use as a climbing harness is particularly preferred. In this case, the first belt sub-element is a hip belt and the second belt sub-element is a leg sling, usually with a webbing of the hip belt being located in the first webbing opening and a webbing of the leg sling being located in the second webbing opening. As a rule, this belt will have an additional leg sling and an additional fitting part, which can preferably be formed of two parts like the first-mentioned fitting part or, according to the state of the art, in one piece. In this case, too, usually a webbing of the hip belt is guided through a first webbing opening of the additional fitting part and a webbing of the additional leg sling is guided through a second webbing opening of the additional fitting part.

The belt described previously can be manufactured with the following steps:
providing the two parts in a separated state,
providing the first and the second belt sub-elements, with the ends of the webbings of the two belt sub-elements being pre-formed into loops, preferably by sewing,
pushing the (first) loop of the webbing of the first belt sub-element onto the first groove, e.g., by pushing the first loop onto the second part, which forms an external part of the body, in such a way that the first loop encloses the second part,
pushing the (second) loop of the webbing of the second belt sub-element onto the first groove or onto the second groove, e.g., by pushing the second loop onto the second part, which forms an external part of the body, in such a way that the second loop encloses the second part,
bringing the two parts into the assembled state, wherein the loop of the webbing of the first belt sub-element is located in the first webbing opening and the loop of the webbing of the second belt sub-element is located in the first webbing opening or in the second webbing opening, and optionally inserting the screw or screws into the transverse hole or the transverse holes in order to connect the two parts in a semi-permanent way.

This manufacturing process is also applicable as part of a maintenance process in which one of the belt sub-elements or the fitting part is to be replaced. In this case, the two parts are first brought from the assembled state into the separated state, and the loops are removed from the grooves, and said manufacturing process is then carried out.

If one of the parts comprises the aforementioned third groove, the manufacturing process furthermore comprises the following steps, which are carried out before the two parts are brought into the assembled state:
providing a flexible bridge with an end that has been pre-formed into a loop,
pushing the loop of the flexible bridge onto the web or sliding the web through the loop of the flexible bridge.

If a screw is used as a web, it is first guided through a first section of the transverse hole and there preferably passes through both the first and the second parts until the screw protrudes into the bridge hole. Subsequently, the screw is guided through the loop of the flexible bridge, which is located in the bridge hole. The screw is then pushed further through a second section of the transverse hole, which preferably passes through both the first and the second parts. Finally, the screw is preferably screwed into the transverse hole or with a nut located outside of the fitting part.

### BRIEF DESCRIPTION OF THE DRAWINGS

Advantageous and non-limiting embodiments of the invention are explained in further detail below with reference to the drawings.

FIG. 1 shows a belt for personal fall protection according to the prior art.

FIGS. 2a and 2b show a method of connecting belt sub-elements to a fitting part according to the prior art.

FIGS. 3a and 3b show a method of connecting belt sub-elements to a fitting part according to the invention.

FIGS. 4 to 8 show different embodiments of parts of the body in order to form openable webbing openings and bridge holes.

FIGS. 9a and 9b show a first preferred embodiment of the fitting part according to the invention with two screws.

FIGS. 10a and 10b show a second preferred embodiment of the fitting part according to the invention with a screw that is usable as a web in the bridge hole.

FIGS. 11a and 11b show an attachment of a flexible bridge on a fitting part with a static bridge hole.

FIGS. 12a and 12b show an attachment of a flexible bridge on a fitting part with an openable bridge hole and a permanent web.

FIGS. 13a and 13b show an attachment of a flexible bridge on a fitting part with a static bridge hole and a removable screw as a web.

FIGS. 14a and 14b each show a variant in which a transverse hole for a screw runs through the front side and the back side.

### DETAILED DESCRIPTION

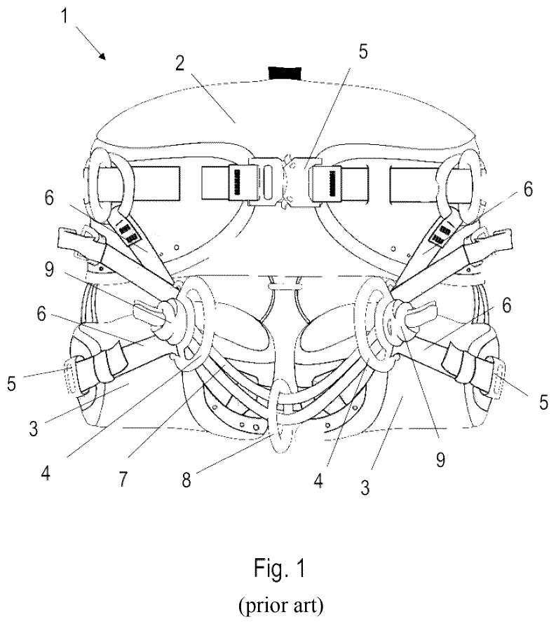

FIG. 1 shows a belt 1 for personal fall protection, which, in the illustrated embodiment, is designed as a climbing harness, which is also referred to as a seat belt or a safety belt. This belt 1 comprises a hip belt 2 and two leg slings 3, which are connected to the hip belt 2 via fitting parts 4. However, the invention is not limited to this specific embodiment, but the belt could also comprise further or, respectively, other elements such as a chest belt, for example, in which case the belt could be referred to as a safety harness. In general, the elements such as the hip belt 2, the leg slings 3 or a chest belt are referred to as belt sub-elements enclosing body parts.

The belt sub-elements are generally designed as open straps the ends of which are connected with a buckle 5 in order to form the strap into a loop that can be placed around a body part, as depicted in FIG. 1. By means of a length adjusting device in the area of the buckle 5, the belt sub-elements can be designed so as to be adjustable in size. Such embodiments can be provided for both the hip belt 2 and the leg slings 3. The belt sub-elements are generally made of a textile material and can be provided with a reinforcing leather part, for example.

The fitting parts 4 are used as a connection point between the belt sub-elements. The fitting parts 4 can thereby simultaneously form a force transmission point between the body of the user of the belt 1 and an anchor point at which the user of the belt 1 is to be secured. In order to enable even force transmission, usually one fitting part 4 is provided on the left of the belt 1 and one fitting part 4 is provided on the right thereof, and a flexible bridge 7 (such as one or several ropes or a webbing) is hooked in between the fitting parts 4. Subsequently, the bridge 7 can be attached to an anchor point, which can be facilitated by a ring 8 located on the bridge between the fitting parts 4. In the example shown, the bridge 7 is fixed in a bridge hole of the fitting part 4 by the bridge which is tied at the ends, see the knots 9 in FIG. 1. The length can be adjusted by positioning the knot.

In order to connect the belt sub-elements to each other or, respectively, to the fitting parts 4, thereby enabling proper force transmission, the belt sub-elements usually have webbings 6 running, for example, through the entire belt sub-element. As a result, especially a good force transmission between the webbings 6 of a belt sub-element and the body of a user is achieved. It is evident from FIG. 1 that the hip belt 2, i.e., the first belt sub-element, has a first webbing 6 and the leg slings 3, i.e., the second belt sub-elements, each have a second webbing 6. The first webbing and the second webbing connect the hip belt 2, i.e., the first belt sub-element, and the leg slings 2, i.e., the second belt sub-elements, to the fitting part 4. The first webbing and the second webbing could also be made of different materials.

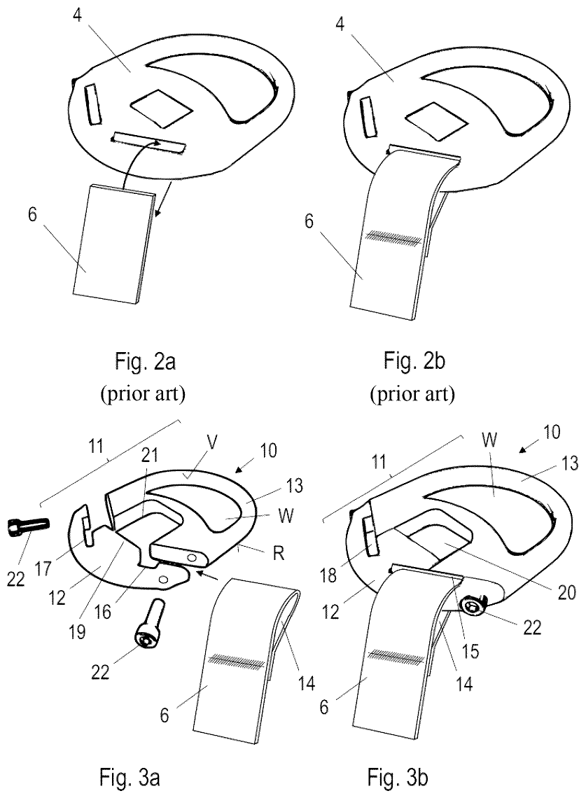

FIGS. 2a and 2b show how the webbings 6 are connected to the fitting parts 4 when the latter are designed as non-openable elements, as is common in the prior art. FIG. 2a shows that the webbings 6 must first be guided through webbing openings of the fitting parts 4. Only then can the ends of the webbings 6 be sewn up to form a loop, as is shown in FIG. 2b, in order to generate a secure connection between the belt sub-elements and the fitting part 4. The mutual connection of the belt sub-elements via the fitting parts 4 is thus designed to be inseparable, whereby subsequent replacement of one of the elements is not possible. Furthermore, this manufacturing process involves the disadvantage that the loops on the webbings 6 cannot be produced in advance, which would be beneficial in terms of process engineering.

These disadvantages can be overcome if, as shown in FIGS. 3a, 3b, a fitting part 10 according to the invention is used, which comprises a body 11 that has a first part 12 and a second part 13. The body 11 and subsequently also the parts 12, 13 are preferably made of metal, and, furthermore, they are preferably designed as flat parts. Such a flat body 11 usually has a thickness, measured from a front side V to a back side R, of 6 mm to 14 mm, preferably of 8 mm to 10 mm. Since it is a flat body, the thickness is usually the smallest distance from the outer surfaces. The parts 12, 13 also have this thickness so that it is preferably the smallest distance from the outer surfaces also for the parts 12, 13.

As shown in FIG. 3a, the first part 12 and the second part 13 can be brought into a separated state so that a prefabricated loop 14 of a webbing 6 can be inserted between them, as will be explained in detail below. In FIG. 3b, it is depicted that the first part 12 and the second part 13 can also be brought into an assembled state in which the prefabricated loop 14 of the webbing 6 is confined in a first webbing opening 15 of the fitting part 10. In this state, the webbing 6 and thus the respective belt sub-element is connected to the fitting part 10. The prefabricated loops 14 have preferably been produced by sewing, optionally also by providing a buckle.

In the assembled state of the parts 12, 13, the body 11 thus exhibits at least the first webbing opening 15, which passes through the body 11 and thereby passes through the front side V and the back side R of the body 11. The first webbing opening 15 is arranged entirely within the front side V or, respectively, the back side R of the body 11, as seen in a second direction extending from the front side V to the back side R, so that the webbing 6 can be confined in the body 11. In the separated state of the parts 12, 13, the first webbing opening 15 is cleared, i.e., the first webbing opening 15 is opened in a first direction which is located normally to a second direction in which the first webbing opening 15 passes through the body 11. To enable this, the first part 12, for example, has a first external groove 16. The second part 13 has an outer surface complementary to the formation of the webbing opening 15, e.g., a planar outer surface or a further first groove. Conversely, only the second part 13 could have a first external groove 16 and the first part 12 could have a planar outer surface, or both parts 12, 13 could have a first groove 16.

As can be seen in FIG. 3b, the first part 12 and the second part 13 thus touch each other in the assembled state at least in two places, and, between those places, the first part 12 and the second part 13 are spaced apart by the first external groove 16 so that the webbing 6 can be received therein.

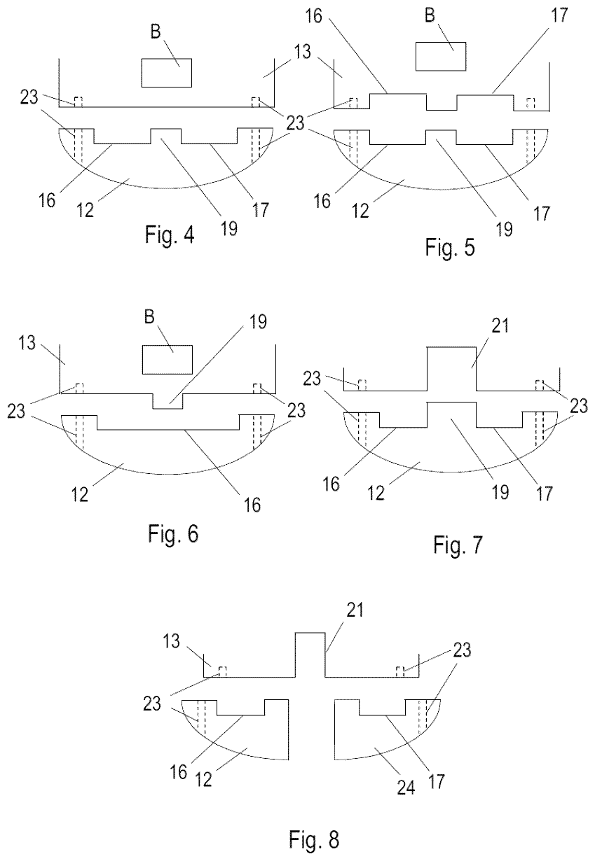

The first external groove 16 can be designed to be so long that both a webbing 6 of the first belt sub-element and a webbing 6 of the second belt sub-element can end up lying therein. To prevent the webbings 6 of the belt sub-elements from touching each other, the first groove 16 and a second groove 17 can also be provided, as shown in FIGS. 3a, 3b, in order to provide the first webbing opening 15 and a second webbing opening 18 in the body, which do not blend into each other and are therefore separate, in the assembled state of the parts 12, 13. This is illustrated schematically also in FIG. 4. The first groove 16 and the second groove 17 can both be present only in the first part 12 or in the second part 13 (i.e., one of the parts 12, 13 has two grooves for the webbings, as shown in FIG. 4), with the respective other part 12, 13 having a planar outer surface for both of the grooves to form the two webbing openings 15, 18. Otherwise, the first part 12 could also have a first groove 16 and the second part 13 could have a planar outer surface for the first webbing opening 15, whereas the second part 12 could have a second groove 16 and the first part 13 could have a planar outer surface for the second webbing opening 18. Both parts 12, 13 could also have grooves for both of the webbing openings 15, 18.

FIG. 5 shows such an embodiment in which both parts 12, 13 have grooves 16, 17 for both of the webbing openings 15, 18. It shall be understood that also only one of the webbing openings 15, 18 could be formed by two diametrically opposed grooves 16, 17.

In a further variant, which is illustrated in FIG. 6, one of the parts 12, 13 could have a long first groove 16 and the respective other one of the two parts 12, 13 could have a projection 19 which, in the assembled state, engages into the first groove 16 to thereby form a second webbing opening 18, which is separate from the first webbing opening 15.

In FIGS. 4 to 6, a non-openable, static bridge hole B is provided in the second part 13, in which the flexible bridge 7 can be anchored, as described below. However, an openable bridge hole 20, which passes through the body 11 in the assembled state of the parts 12, 13, could also be provided, as shown in FIGS. 3a, 3b and FIGS. 7 and 8. For this purpose, the first and/or the second part(s) 12, 13 can have a third groove 21, with the respective other part 12, 13 having a complementary outer side in order to form a bridge hole 20 on the third groove 21 in the assembled state of the two parts 12, 13, which bridge hole is separate from the first webbing opening 15 and from the second webbing opening 18 that is present, if necessary. As an alternative to the third groove 21, two projections could also be provided in line with FIG. 6 in order to provide both the first webbing opening 15 and the second webbing opening 18 as well as the bridge hole 20 in the first groove 16. The bridge hole 20 is usually provided between the two webbing openings 15, 18 in order to achieve symmetry. In the area of the bridge hole 20, the first groove 16 can also project further into the respective part in order to achieve a larger bridge hole 20, or the respective other part can provide a separate third groove 21 just for the bridge hole 20 so that the bridge hole 20 can be designed so as to be larger than the two webbing openings 15, 18. The background to this is that the two webbing openings 15, 18 are supposed to accommodate flat belts, while the bridge hole 20 can also be designed to accommodate a rope. In general, it is therefore preferred for all embodiments if the bridge hole 20 is dimensioned differently than the webbing openings 15, 18. For example, the bridge hole 20 could be larger than the webbing openings 15, 18 and/or the bridge hole 20 could have an approximately square shape, while the webbing openings 15, 18 have a rectangular, elongated shape. These variants are beneficial also for a non-openable, static bridge hole B.

The preferred embodiment, however, is that of FIG. 7, in which the first part 12 has a first groove 16 and a second groove 17 spaced apart by a projection 19, and the second part 13 has a third groove 21. The third groove 21 is closed on one side by a projection 19 to form the bridge hole 20, and the first groove 16 and the second groove 17 are closed on one side by two outer surfaces of the second part 13, which are present laterally of the third groove 21, in order to form the first webbing opening 15 and the second webbing opening 18 therein, respectively.

In a further embodiment, which is shown in FIG. 8, the body 11 could comprise a third part 24 so that the body 11 does not consist of two parts 12, 13 as in FIGS. 4-7, but of three parts 12, 13, 24. In this embodiment, the first webbing opening 15 is confined between the first part 12 and the second part 13, and the second webbing opening 18 is confined between the second part 13 and the third part 24. The openable bridge hole 20 is optional and can be confined between two or between three of the parts 12, 13 and 24. The parts 12 and 24 interlock in such a way that, in the closed state, they cannot be twisted relative to each other around the screws 22 in the transverse holes 23.

In the assembled state of the belt 1, a webbing 6 of the first belt sub-element is thus located in the first webbing opening 15, a webbing 6 of the second belt sub-element is located in the second webbing opening 18, and a flexible bridge 7 is anchored in the bridge hole B/20.

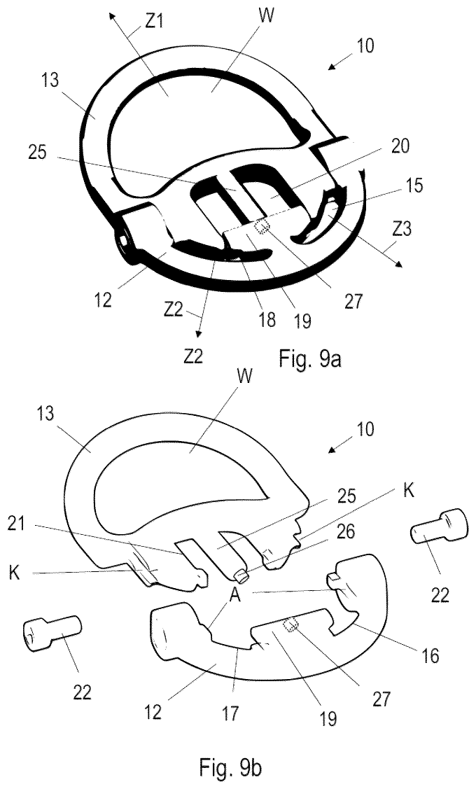

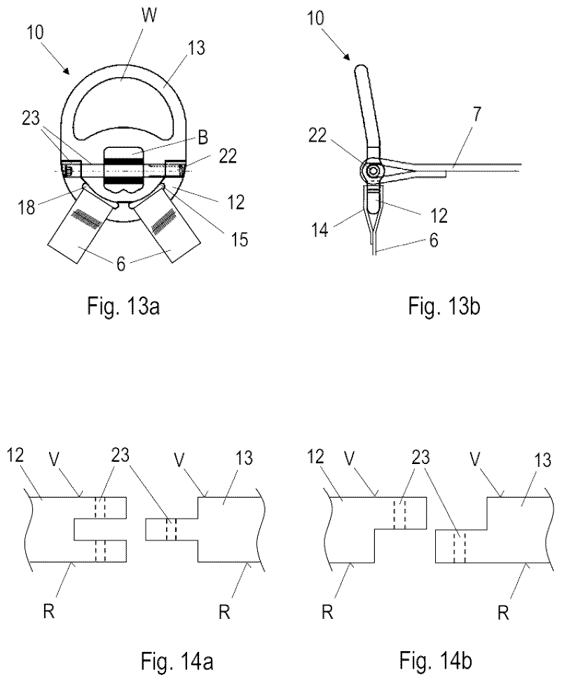

For achieving a secure, semi-permanent connection in the assembled state of the two parts 12, 13, screws 22 can be used, for example, in order to connect the first part 12 to the second part 13. For this purpose, the body 11 of the fitting part 10 furthermore has at least one transverse hole 23, which is arranged at a predetermined distance from a front side V and a back side R of the body 11, the transverse hole 23 passing through both the first part 12 and the second part 13. The screw 22 can now be locked in the transverse hole 23, for example if an internal thread is provided in the transverse hole 23. The internal thread can optionally be located only in the first and/or second part(s) 12, 13. In one of the two parts 12, 13, the transverse hole 23 can also be designed as a blind hole and can exhibit the internal thread there, with the transverse hole 23 completely passing through the other part. The transverse hole 23 can also completely pass through both parts 12, 13, wherein the screw 22 can optionally protrude from the body 11 on one or both sides and is fastened to the body there by means of a nut. In a special case, the screw 22 can be accommodated completely in the transverse hole 23, as is illustrated in FIG. 13a, this being feasible also with screws 22 as shown in FIGS. 3a, 3b, 9a, 9b, which do not pass through the bridge hole 20. In a special case, the transverse hole 23 could be provided as a blind hole in both parts 12, 13, and the screw 22 could be inserted therein in the form of a pin.

In the embodiment of FIG. 8, at least two transverse holes 23 can be used to connect all three parts 12, 13, 24.

In some embodiments, as shown in the example of FIGS. 3a and 3b, two screws 22 are used to ensure a secure connection of the two parts 12, 13. Alternatively, however, only one screw 22 or more than two screws 22 could also be provided.

It is generally envisaged that one of the two parts 12, 13 (in the embodiments depicted herein, the second part 13) is passed through by a static, non-openable further opening W, which does not abut on the edge of the respective part 12, 13. This (optional) further opening W is intended for connection to an anchor point, for which purpose a carabiner of a connecting element is usually hooked into the further opening W. If a static, non-openable bridge hole B is provided, it is typically provided in the same part 12, 13 as the further opening W.

If the fitting part 10 has such a further opening W for an anchor point, a pull direction Z1 can be defined on the fitting part 10, wherein a pulling force acts, which takes effect at an anchor point connected to the further opening W. The user can hang in the belt 1 against the pulling force, with pulling forces diametrically opposed to the pulling force occurring in pull directions Z2, Z3 on the webbings 6 in the webbing openings 15, 18.

The body 11 is usually designed to be essentially symmetrical around the pull direction Z1, which includes minor deviations that are caused, for example, by anatomical reasons. Where applicable, the symmetrical body 11 can be understood to mean that it is mirror-symmetrical around the pull direction Z1, wherein the webbing openings 15, 18 can deviate from this symmetry. If no pull direction Z1 can be defined, any other mirror axis could also be used. If the two parts 12, 13 are connected by means of screws 22, the latter are preferably not located in parallel to the pull direction Z1 or, respectively, the mirror axis, but are arranged at an angle thereto, as shown in FIGS. 3a, 3b. In particular, the screws 22 are preferably located normally to the pull direction Z1 or, respectively, the mirror axis, as is shown in the embodiment of FIGS. 9a and 9b. However, it shall be understood that differently designed and, in particular, completely asymmetrical bodies 11 could also be used and the arrangement of the screws 22 can also be arbitrary.

Furthermore, it should be emphasized at this point that the screws 22 or, respectively, the transverse holes 23 are still not mandatory, since the first part 12 and the second part 13 can also be interconnected using general connectors such as clamps or the like. As a rule, the fitting part 10 is therefore formed by the body 11 and the connectors for connecting the two parts 12, 13.

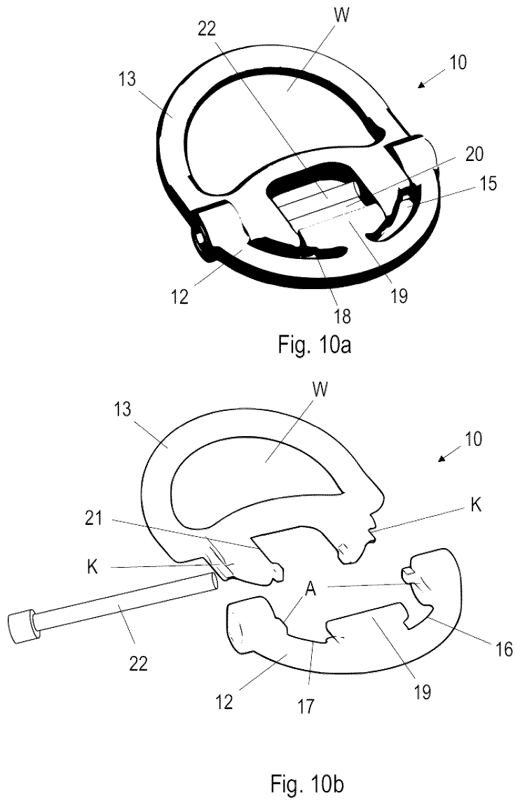

Furthermore, the contact points of the first and the second parts 12, 13 can also have, for example, diametrically opposed surfaces engaging with each other in order to enable a connection or, respectively, to further strengthen the connection between the two parts 12, 13. It is evident from FIGS. 9b, 10b that the first part 12 has a shoulder A in two places which engages into a diametrically opposed notch K in the second part 13. However, the shape of the diametrically opposed surfaces can be chosen arbitrarily. The diametrically opposed surfaces engaging with each other can be arranged along the entire contact surface or only across a part, as shown in FIGS. 9b, 10b.

For the connection of the flexible bridge 7 to the fitting part 10, the body is passed through by the bridge hole already mentioned, which can be designed either as a static bridge hole B or as an openable bridge hole 20. A static bridge hole B passes through the first and/or the second part(s) 12, 13, as depicted in FIGS. 4 to 6, i.e., it does not abut on an outer side of the respective part 12, 13. However, as already explained above, the bridge hole 20 can also be designed so as to be openable and can be present between the two parts 12, 13 in order to pass through the body 11 at this point, i.e., at least one of the two parts 12, 13 exhibits the third external groove 21.

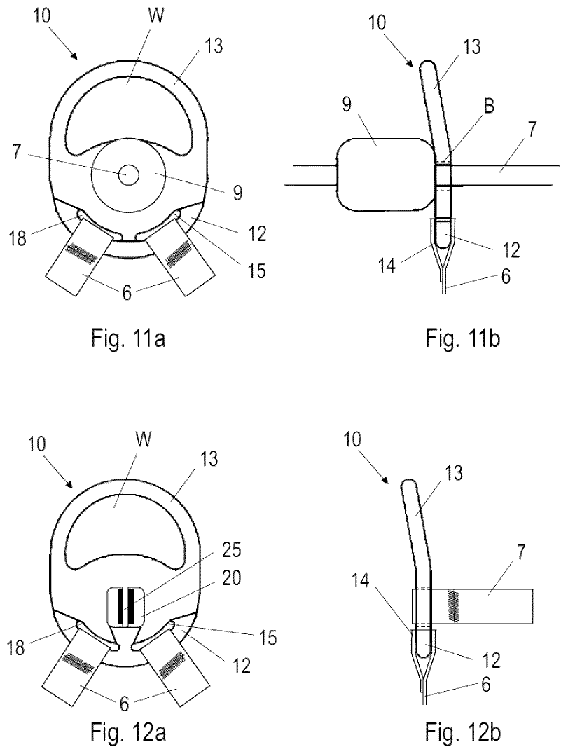

In general, the bridge hole B, 20 can be divided by a web 25, i.e., it can be passed through by a web 25 or bridged by a web. For bridging the bridge hole B. 20, a detachable web can be used, as shown in EP 3 332 840 A. Other novel embodiments for the web will be described below. It should be noted, however, that a web 25 is by no means necessary, as shown, for example, in FIGS. 3a, 3b, 11a, 11b. In the embodiments without a web, a stopper knot is usually provided at one end of the flexible bridge 7, which prevents the flexible bridge 7 from being pulled through the bridge hole 20. However, a web 25 can also be provided when using a bridge 7 with stopper knots in order to reduce the size of the bridge hole 20 and prevent the stopper knot from slipping through.

FIGS. 9a, 9b, 12a, 12b show embodiments in which the bridge hole 20 is passed through by a web 25. In these embodiments, the bridge hole 20 is designed so as to be openable, i.e., the first and/or the second part(s) 12, 13 exhibit(s) the aforementioned third groove 21 so that the bridge hole 20 passes through the body 11 in the assembled state. The web 25 is designed such that it is present at the third groove 21 in a state of being open on one side, when the two parts 12, 13 are separated. The web 25 is preferably located in parallel to the aforementioned pull direction Z1 or, respectively, axis of symmetry. In these cases, a loop of the flexible bridge 7, which is formed on the end side, can be hung onto the web 25 in the separated state of the two parts 12, 13. When the two parts 12, 13 are then brought into the assembled state, the loop of the flexible bridge 7 is confined between the two parts 12, 13 in the body 11. Thus, the flexible bridge 7 cannot be removed from the fitting part 10 when the two parts 12, 13 are in the assembled state. For removing the flexible bridge 7 or, respectively, replacing it with another flexible bridge, the two parts 12, 13 are brought into the separated state, which can be done, for example, by opening the aforementioned screws 22. Such a web 25 can also be used, for example, in the embodiments of FIGS. 3a, 3b. The web 25 can also have an extension 26 which can engage into a recess 27 of the respective other part 12, 13 in order to increase the stability of the body 11 in the assembled state of the two parts 12, 13. The web 25 could also have a smaller diameter than the thickness of the body 11 and could thus be inserted into the recess 27—assuming the stability of the resulting fitting part that is required due to the application in personal fall protection. In a further embodiment, the web 25 could, for example, have a tubular design, and, instead of a recess 27, the respective other part 12, 13 has a pin that fits into the tubular web 25. The pin can then be pushed into the tube, when the two parts 12, 13 are put together.

In a further embodiment, which is illustrated in FIGS. 10a, 10b, 13a, 13b, the web 25 can also be formed by the aforementioned screw 22, which interconnects the two parts 12, 13. In this case, the transverse hole 23 passes through the two parts 12, 13 on both sides of the bridge hole 21 so that a single screw 22 interconnects the parts 12, 13 at two different points. The screw 22 can thus pass through the bridge hole 20. As a result, one loop of the flexible bridge 7 can, in turn, be pushed onto the screw 22. This variant, wherein the screw 22 passes through the bridge hole, can be used with an openable bridge hole 20, as shown in FIGS. 10a, 10b, or with a static bridge hole B, as shown in FIGS. 13a, 13b.

FIGS. 11a-13b show three variants for manufacturing the belt 1 with three different fitting parts 10. All three variants have in common that at least two belt sub-elements with webbings 6 are initially provided, with the ends of the webbings 6 preferably being pre-formed into loops. Furthermore, the fitting part 10 is provided, with the parts 12, 13 being present in the separated state.

In the variant of FIGS. 11a, 11b, a fitting part 10 is provided in which the first webbing opening 15 and the second webbing opening 18 are designed so as to be openable. The bridge hole B, on the other hand, is provided as an opening which continuously passes through the second part 13 and cannot be opened by separating the parts 12, 13. To produce the belt 1, the loop 14 of one webbing 6 is inserted into the first groove 16, which will later form the first webbing opening 15. The loop 14 of the other webbing 6 is inserted into the second groove 16, which will later form the second webbing opening 18. Subsequently, the two parts 12, 13 are brought into the assembled state, and, optionally, they are connected by means of the screws 22. Beforehand or afterwards—and generally independently of the aforementioned steps—the flexible bridge 7 can be guided through the bridge hole 20 and can be tied or, respectively, provided with a prefabricated knot and can be guided with the untied end through the bridge hole 20. It shall be understood that this embodiment could also be implemented with an openable bridge hole 20. The fitting part 10 could then be designed like in FIGS. 3a, 3b, wherein a web 25 could optionally run through the bridge hole 20, the purpose of which would, in this case, be a reduction in the size of the bridge hole 20 so that the stopper knot is better secured.

In the variant of FIGS. 12a, 12b, a fitting part 10 is provided in which the first webbing opening 15, the second webbing opening 18 and the bridge hole 20 are designed so as to be openable. In the bridge hole 20, a permanent web 25, which is designed to be open on one side, is formed on the third groove 21. This essentially corresponds to the embodiment of FIGS. 9a, 9b. To produce the belt 1, the loop 14 of one webbing 6 is inserted into the first groove 16, which will later form the first webbing opening 15. The loop 14 of the other webbing 6 is inserted into the second groove 16, which will later form the second webbing opening 18. Furthermore, a flexible bridge 7 is provided, one end of which is pre-formed into a loop. The loop of the flexible bridge 7 is pushed onto the web 25. Subsequently, the two parts 12, 13 are brought into the assembled state, and, optionally, they are connected by means of the screws 22.

In the variant of FIGS. 13a, 13b, a fitting part 10 is provided in which the first webbing opening 15 and the second webbing opening 18 are designed so as to be openable. The bridge hole B has a static design, but could also be designed so as to be openable, as in FIGS. 10a, 10b. No permanent web is formed in the bridge hole B, but it is formed by a screw 22 that is insertable into the body 11. To produce the belt 1, the loop 14 of one webbing 6 is inserted into the first groove 16, which will later form the first webbing opening 15. The loop 14 of the other webbing 6 is inserted into the second groove 16, which will later form the second webbing opening 18. Subsequently, the two parts 12, 13 are brought into the assembled state. The screw 22 is then guided through a first section of the transverse hole 23 until it projects into the bridge hole B. A flexible bridge 7 is then provided, one end of which is pre-formed into a loop, and the loop is inserted into the bridge hole B. Subsequently, the screw 22 is pushed further through the loop and the second section of the transverse hole 23 and is screwed together with an internal thread in this second section or with a nut located outside of the fitting part.

In FIGS. 11a, 11b, the flexible bridge 7 is depicted as a rope bridge. This is preferred in order to create a knot 9. In FIGS. 12a-13b, the flexible bridge 7 is illustrated as a webbing with its end sewn up to form a loop. However, this could be implemented equally if the flexible bridge 7 is formed by one or several ropes, which usually corresponds to the preferred embodiment.

In all above-mentioned embodiments, it is preferred that the ends of the webbings 6 are sewn up (beforehand) to form loops. Alternatively, however, buckles or the like could also be used to form the ends of the webbings 6 into loops. In this case, the fitting parts 10 according to the invention furthermore enable advantageous assembly and/or advantageous maintenance of the belt 1.

In all embodiment variants described above, it has been envisaged that the transverse hole 23 runs between the front side V and the back side R and is spaced apart therefrom, whereby a semi-permanent connection is realized in order to connect the two parts 12, 13 to each other in a non-rotatable way and to achieve a rigid body 11. Alternatively, however, the transverse hole 23 could also pass through the front side V and the back side R of the body 11. Possible embodiment variants for this are illustrated in FIGS. 14a and 14b.

In FIG. 14a, the first part 12 has a groove and the second part 13 has a projection. The transverse hole 23 runs specifically through the outer sides of the groove and through the projection so that a screw can be guided through the transverse hole 23 in the assembled state of the two parts 12, 13 in order to connect the two parts to each other in a semi-permanent way.

FIG. 14b shows an embodiment in which both the first part 12 and the second part 13 each have a projection, wherein the projections are complementary to each other so that the two parts 12, 13 can be put together to form the body 11. The transverse hole passes through both projections.

In the embodiments of FIGS. 14a and 14b, two transverse holes 23 are usually provided, each of them passing through both parts 12, 13, whereby the two parts 12, 13 can be connected by means of two screws 22.

1-16. (canceled)

17. A belt for personal fall protection, the belt comprising:
a fitting part and at least a first and a second belt sub-element enclosing a body part;
the fitting part comprising a body that is designed to be connected to the first belt sub-element, to the second belt sub-element and to a flexible bridge,
wherein the body is passed through by a first webbing opening and by a bridge hole, with the body of the fitting part comprising a first part and a second part which can be brought into an assembled state and into a separated state,
with the first part and/or the second part comprising at least one first external groove for the first belt sub-element,
wherein, in the assembled state of the two parts, the first groove is completed by the respective other part to form the first webbing opening passing through the body in order to connect therein a first webbing of the first belt sub-element enclosing a body part to the fitting part in a semi-permanent way, wherein
the body of the fitting part furthermore has at least one transverse hole passing through both the first part and the second part,
wherein the fitting part further comprises a screw, wherein the screw is configured to be guided into the transverse hole and configured to be locked therein in order to connect the first part to the second part in the assembled state.

18. The belt according to claim 17, wherein the first part and/or the second part comprises at least one second external groove for the second belt sub-element, wherein, in the assembled state of the two parts, the second groove is completed by the respective other part to form a second webbing opening passing through the body in order to connect therein a second webbing of the second belt sub-element enclosing a body part to the fitting part.

19. The belt according to claim 17, wherein the first part and/or the second part comprise(s) at least one third external groove for the flexible bridge, wherein, in the assembled state of the two parts, the third groove is completed by the respective other part to form a bridge hole passing through the body in order to connect therein the flexible bridge to the fitting part.

20. The belt according to claim 17, wherein the transverse hole is arranged at a predetermined distance from a front side and a back side of the body.

21. The belt according to claim 20, wherein the body is designed to be essentially symmetrical around a pull direction and the transverse hole is arranged at an angle to the pull direction.

22. The belt according to claim 17, wherein the transverse hole passes through a front side and a back side of the body.

23. The belt according to claim 17, furthermore comprising a web which divides the bridge hole.

24. The belt according to claim 23, wherein the body is designed to be essentially symmetrical around a pull direction and the web runs in parallel to the pull direction.

25. The belt according to claim 23, wherein the body is designed to be essentially symmetrical around a pull direction and the web runs normally to the pull direction.

26. The belt according to claim 23, wherein the web is integrally formed on the first part or on the second part and wherein the part opposite the web comprises a recess for receiving the web or for receiving an extension of the web in the assembled state of the parts, or wherein the web has a tubular design and the part opposite the web comprises a pin for engaging into the web.

27. The belt according to claim 23, wherein the web is formed by the screw.

28. The belt according to claim 17, wherein the first part and the second part have interlocking guide surfaces at the points touching each other in the assembled state of the two parts.

29. The belt according to claim 17, wherein the body has a thickness, measured from a front side to a back side, of 6 mm to 14 mm, of 8 mm to 10 mm.

30. The belt according to claim 17, wherein the first belt sub-element is a hip belt and the second belt sub-element is a leg sling, with the belt comprising an additional leg sling and an additional fitting part connecting the hip belt to the additional leg sling, the additional fitting part particularly being designed in the same way as the first-mentioned fitting part.

31. A method of producing a belt according to claim 17, the method comprising:
providing the two parts in a separated state,
providing the first and the second belt sub-elements, with the ends of the webbings of the two belt sub-elements being pre-formed into loops, being sewn up to form loops,
pushing the loop of the webbing of the first belt sub-element onto the first groove,
pushing the loop of the webbing of the second belt sub-element onto the first groove or onto the second groove,
bringing the two parts into the assembled state, wherein the loop of the webbing of the first belt sub-element is located in the first webbing opening and the loop of the webbing of the second belt sub-element is located in the first webbing opening or in the second webbing opening.

32. The method according to claim 31, further comprising steps which are carried out before the two parts are brought into the assembled state including:
providing a flexible bridge with an end that has been pre-formed into a loop,
pushing the loop of the flexible bridge onto the web or sliding the web through the loop of the flexible bridge.
